(19) United States
(12) Patent Application Publication
(10) Pub. No.: US 2004/0046158 A1
(43) Pub. Date: Mar. 11, 2004

(54) Use of water-in-water polymer dispersions for prevention and fighting of fires

(76) Inventor: Wolfgang Hubner, Kempen (DE)

Correspondence Address: SMITH MOORE LLP, P.O. BOX 21927, GREENSBORO, NC, 27420, US

(21) Appl. No.: 10/376,105

(22) Filed: Feb. 27, 2003

(30) Foreign Application Priority Data
Aug. 23, 2000 (DE) 100 41 394

(51) Int. Cl. C09K 21/00

(52) U.S. Cl. 252/601

(57) ABSTRACT

The present invention relates to the use of water-in-water polymer dispersions, comprising a continuous aqueous phase and cross-linked, water-swellable polymers finely distributed therein, for fire protection and firefighting. Furthermore, the present invention relates to devices for fire protection and firefighting.

The present invention relates to the use of water-in-water polymer dispersions, comprising a continuous aqueous phase and cross-linked, water-swellable polymers finely distributed therein, for fire protection and firefighting. Furthermore, the present invention relates to devices for fire protection and firefighting.

For effective protection from and fighting of fires, additives having thickening properties are used to increase the viscosity of the fire extinguishing water in order to achieve improved adhesion of the fire extinguishing agent to surfaces, particularly slanted surfaces, in comparison to water. Most of the known fire extinguishing water additives comprise water-swellable polymers, whose applicability is restricted due to their solid, granular morphology, however.

In order to overcome this disadvantage, polymer dispersions in the form of water-in-oil emulsions have recently been used for fire protection and/or firefighting, as are described in European Patent Application 0 774 279 B1. These emulsions comprise a continuous oil phase, in which particles of a cross-linked, water-swellable polymer are dispersed. In this way, these water additives may be introduced into the water supply in liquid form, so that they may be delivered using the typical firefighting devices. The polymer particles have particle sizes <2 μm, due to which extremely short swelling times of <3 seconds result. In addition to their high water absorption capacity, the water-in-oil emulsions have the properties of a thickener, so that after mixing with water, a high-viscosity fire extinguishing agent and/or fire protection agent is obtained, which adheres well to any type of, surface, particularly to slanted surfaces.

These additives to fire extinguishing water have the disadvantage of a comparatively low environmental compatibility, particularly their toxic effects in relation to microorganisms, particularly in relation to algae and daphnia. EC₅₀ values, which are determined pursuant to OECD Guideline 201, are used as a measure for the toxicity of a substance in relation to algae, and corresponding EC₅₀ values, which are determined pursuant to OECD Guideline 202, are used as a measure for the toxicity in relation to daphnia. Due to their toxicity in relation to microorganisms, the known water additives are classified as “environmentally hazardous” according to European law and must be identified using the hazard symbol “N”. The use of the water additives according to the related art is therefore questionable above all when they are used in the countryside, i.e., outside of places equipped with a sewer system or water retaining basins, such as in forests or brush fires. Furthermore, water-in-oil polymer dispersions have the disadvantage that they contain a combustible oil phase.

Furthermore, stable, free-flowing dispersions of water soluble polymers, which may be used as a flocculants and thickeners, as agents for soil conditioning, and as adhesives, dispersing agents, and as additives for foods, pharmaceuticals, and cosmetics, are known from German Patent 29 24 663 C2.

The object of the present invention is therefore to provide a water additive for firefighting that is ecologically better and has fewer combustible components.

The object is achieved according to the present invention by the use of water-in-water polymer dispersions, comprising a continuous aqueous phase and cross-linked, water-swellable polymers distributed finely therein and possibly auxiliary agents, for fire protection and firefighting.

Water-in-water polymer dispersions according to the present invention and methods for their production are described in European Patent Application 670 333 B1, European Patent Application 761 701 B1, and European Patent Application 664 302 B1, which are hereby incorporated by reference and are considered part of the disclosure.

The water-in-water polymer dispersions to be used according to the present invention are a class of products that are produced according to the methods cited as a primary dispersion by polymerization in the liquid phase, e.g., by emulsion polymerization or suspension polymerization. In this case, monomers or a monomer solution are added to an aqueous phase containing at least one dispersing agent and the resulting mixture is polymerized. The particle sizes of the polymers of this primary dispersion are in the range from 0.05 to 10 μm, preferably in the range from 0.5 to 5 μm.

According to the present invention, the aqueous monomer solution contains at least one polymerizable, hydrophilic monomer. However, it may also contain two or more monomers from the group of hydrophilic monomers.

Hydrophilic monomers are, for example,

olefinic unsaturated carboxylic acids and carboxylic acid anhydrides, particularly acrylic acid, methacrylic acid, itaconic acid, crotonic acid, glutaconic acid, maleic acid, and maleic acid anhydride, and the water-soluble salts thereof,

olefinic unsaturated sulfonic acids, particularly aliphatic or aromatic vinyl sulfonic acids, such as vinyl sulfonic acid, allyl sulfonic acid, styrene sulfonic acid, particularly acrylic and methacrylic sulfonic acids, such as sulfoethyl acrylate, sulfoethyl methacrylate, sulfopropyl acrylate, sulfopropyl methacrylate, 2-hydroxyl-3-methacryloxypropyl sulfonic acid, and 2-acrylamido-2-methyl propane sulfonic acid (AMPS), and the water-soluble salts thereof, and

water-soluble and/or water-dispersable derivatives of the acrylic and methacrylic acids, particularly acrylamide, methacrylamide, n-alkyl substituted acrylamides, 2-hydroxyethyl acrylate, 2-hydroxyethyl methacrylate, hydroxypropyl acrylate, hydroxypropyl methacrylate, a C₁-C₄ alkyl(meth)acrylate, and vinyl acetate.

The proportion of the hydrophilic monomers, in relation to the total monomer content, is preferably from 1 to 99.9 weight-percent.

The monomer solution may additionally have up to 25 weight-percent of at least one hydrophobic monomer and/or at least one amphiphilic monomer added to it.

Ethylene or ethylene derivatives are preferably used as hydrophobic monomers. Ethylene derivatives which have two hydrophobic substituents R₁ and R₂ at one of the two carbon atoms of the ethylene unit are especially preferred. R₁ is especially preferably a linear C₁-C₅ alkyl residue and R₂ is especially preferably a C₁-C₂₀ alkyl, cycloalkyl, aryl, or aralkyl residue. Examples of such compounds are styrene and/or styrene derivatives, vinyl cycloalkane, and alkyl(meth)acrylates.

Amphiphilic monomers according to the present invention are polymerizable substances that have both a hydrophilic and a hydrophobic property.

Anionic salts of quaternary amines or compounds of the general formula I are preferably used for this purpose:

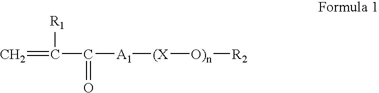

where

A₁—stands for O, NH, or NR₃, with R₃ standing for a C₁-C4 alkyl residue,

R₁—stands for hydrogen or a methyl residue,

R₂—stands for a C₈-C₃₂ alkyl, aryl, or aralkyl residue, and

n⁻ stands for a whole number between 1 and 50.

The monomer solution preferably contains acrylic acid and/or an acrylic acid derivative as monomers, especially preferably at least one salt of acrylic acid and acrylamide and very especially preferably a mixture of acrylic acid, acrylamide, and a salt of 2-acrylamido-2-methyl propane sulfonic acid.

Besides one or more hydrophilic monomers, the monomer solution additionally contains 0.1 to 1 weight-percent of a cross-linking agent. Polyfunctional monomers are used as cross-linkers, such as monomers having at least two radically polymerizable double bonds, monomers having a radically polymerizable double bond and at least one functional group, which may react with a hydrophilic monomer, and monomers having at least two functional groups which may react with two hydrophilic monomers, and/or compounds of a multivalent metal are used, which are provided in the form of oxides, hydroxides, or salts of weak acids, such as salts containing alkaline earth metals, aluminum, zinc, or iron. Such polyfunctional, cross-linking compounds are cited in German Patent 26 12 846 C3 in paragraphs 4 and 5. This publication is hereby incorporated by reference and is thus considered part of the disclosure. The cross-linkers may be used alone or as a mixture of at least two cross-linkers.

The degree of cross-linking of the polymer very significantly influences the viscosity and therefore the adhesion properties of the resulting polymer. Preferably, methylene bisacrylamide, allyl (meth)acrylate, diallyl phthalate, polyethylene glycol di(meth)acrylate, tetraethylene glycol di(meth)acrylate, triethylene glycol di(meth)acrylate, diethylene glycol di(meth)acrylate, glycerin di(meth)acrylate, hydroxypropyl (meth)acrylate, or trimethylol propane tri(meth)acrylate are used as cross-linkers. Triallyl methyl ammonium chloride is especially preferably used as a cross-linking agent.

1 to 50 weight-percent, preferably 2 to 40 weight-percent, especially preferably 5 to 30 weight-percent, each in relation to the dispersion, of at least one dispersing agent is added for dispersing the particles arising during the polymerization.

Homopolymers and copolymers of acrylic acid and acrylic acid derivatives and/or maleic acid and maleic acid derivatives, polycarboxylic acids (POC), polyols, cellulose derivatives having an average molecular weight between 10,000 and 500,000 g/mol, polyalkylene glycols (polyglycol ethers), such as polyethylene glycol, polypropylene glycol, or corresponding block polymers, water-soluble starches and starch derivatives, polyvinyl alcohol, polyvinyl acetate, polyethylenimine, polydiallyl dimethyl ammonium chloride, and inorganic salts, such as sodium sulfate, ammonium sulfate, sodium chloride, and sodium hydrogen phosphate and/or sodium dihydrogen phosphate, are used as dispersing agents. Polyelectrolytes having an average molecular weight in the range between 3,000 and 500,000 g/mol are preferably used.

One of the preceding dispersing agents or a mixture of multiple different dispersing agents may be used for dispersing the polymer particles. It is unimportant in this case for the present invention whether the dispersing agent or the mixture of different dispersing agents is added to the monomer solution completely before the polymerization or the addition is performed step-by-step, i.e., a specific portion of the dispersing agent or the dispersing agent mixture is added to the monomer solution before the polymerization and a further portion is added to the polymer after the polymerization.

The polymerization reaction is started by adding known, radically acting polymerization initiators, such as peroxide compounds, peroxodisulfates, azo compounds, redox systems, and photoinitiators, or by adding a mixture of these compounds. Preferably, peroxodisulfates, azo compounds, and mixtures of redox systems with azo compounds are used. The concentration of polymerization initiators is preferably 10⁻⁵ to 5 weight-percent and especially preferably 10⁻⁴ to 1 weight-percent, in relation to the monomer content.

The oxidizing agent is preferably used in a concentration of 0.00005 to 0.5 weight-percent, preferably 0.001 to 0.1 weight-percent, each in relation to the polymerization solution. Preferably, peroxide compounds, such as alkali metal or ammonium persulfate, alkali metal or ammonium perphosphate, hydrogen peroxide or its salts, benzoyl peroxide, butyl hydroperoxide, or peracids are used for this purpose. However, other oxidation agents, preferably potassium permanganate, sodium or potassium chlorate, and potassium dichromate, may be used.

The reducing agent is also preferably used in a concentration of 0.00005 to 0.5 weight-percent, preferably 0.001 to 0.1 weight-percent, each in relation to the polymerization solution. Preferably, sulfurous compounds, such as sulfites, thiosulfates, sulfinic acid, or organic amines and thiols, low valence metal salts, such as copper (I); manganese (II); iron (II), ascorbic acid, or phosphoric compounds, such as sodium hypophosphite, are used as reducing agents. Suitable initiators are also 2,2′-azobis(isobutyronitrile) and 2,2′-azobis(amidopropane).

In the case of a photo polymerization, the reaction is started using UV light, which causes the decomposition of the starter. Preferably, benzoin and benzoin derivatives, such as benzoin ether, benzyl and its derivatives, such as benzyl ketals, acryl diazonium salts, azo initiators such as 2,2′-azobis(isobutyronitrile), 2,2′-azobis(amidopropane)hydrochloride, 2,2′-azdbis(amidopropane)dihydrochloride, or acetophenone derivatives are used as starters. For photoinitiation, 0.001 to 0.1 weight-percent, preferably 0.002 to 0.05 weight-percent is used.

The polymerization may be performed adiabatically, isothermally, or as a combination of an adiabatic and isothermal method.

The water-in-water polymer dispersion to be used according to the present invention preferably contains 10 to 70 weight-percent, especially preferably 20 to 50 weight-percent, and very especially preferably 25 to 40 weight-percent of cross-linked, water-swellable polymer particles.

The use of water-in-water polymer dispersions, which are produced by dispersing already manufactured polymers in an aqueous phase, which contains at least one dispersing agent, is also according to the present invention. The particle size of the polymers of these secondary dispersions is preferably at least 20 μm.

The polymer particles, however, preferably have a particle size of less than 2 μm, and especially preferably a particle size of less than 1 μm, due to which extremely short swelling times of the polymer particles, less than 3 seconds, result. The short swelling times allow the polymer particles to be completely swollen upon delivery from standard firefighting devices onto sources of fire or surfaces to be protected from fire.

The polymer particles are distributed uniformly in the form of small discrete droplets in the aqueous phase by the dispersing agent. In this way, agglutination and/or clumping of the polymer particles are prevented. Also, the polymer particles may be introduced into the water supply in liquid form and thus may be applied to the sources of fire and/or onto the surface to be protected from fire using the standard firefighting devices.

The polymer particles in the water-in-water polymer dispersions to be used according to the present invention for fire protection and/or firefighting have, besides an extremely short swelling time, a high water absorption capacity. After mixing with water in the firefighting devices, the polymer particles carry more than 90% of the water used for firefighting. If the water/polymer dispersion mixture is applied onto the source of fire during firefighting, more water reaches the fire due to the evaporation time, which is slowed in comparison to pure water. In this way, the fire may be extinguished using a smaller quantity of water than if only water is used and/or if typical extinguishing foam is used. In contrast to the use of water, the polymer dispersion to be used according to the present invention coats the ashes or charred surface of the previously burning structure, so that flaring up again may be prevented. Due to the high water absorption capacity, the water-in-water polymer dispersions are also suitable as an effective fire protection agent, since the fire must overcome the effect of the significant amounts of water bound in the structures of the polymer dispersion. The fire may thus only spread very slowly to the surfaces protected by these agents.

The outstanding suitability of the water-in-water polymer dispersion to be used for fire protection and firefighting according to the present invention is due to, besides the fine distribution of the polymer particles in the dispersion, the short swelling time, and the high water absorption capacity of the polymer particles, their relatively high water-thickening property. In this way, a relatively highly viscous liquid results after mixing with water, which readily adheres to horizontal, slanted, and vertical surfaces. During use as a fire protection agent, this has the effect that the water-containing polymer particles form at least one layer on the surface to be protected. If the fire now approaches this surface, the polymer particles closest to the fire absorb the heat until they have assumed a temperature sufficient for water vaporization and the water contained in the particles vaporizes. The deeper layers of polymer particles are protected from the fire until complete vaporization of the water contained in the uppermost layers. This fire-delaying procedure continues until the water of the polymer particles of the innermost layer is vaporized.

The use of water-in-water polymer dispersions for fire protection and firefighting according to the present invention is distinguished from the use of the agents previously known for this purpose by improved environmental compatibility, particularly through lower toxicity in relation to microorganisms. In contrast to the previously known water-in-oil polymer dispersions, the water-in-water polymer dispersions to be used according to the present invention have EC₅₀ values of over 10 mg/l and sometimes even over 100 mg/l according to the daphnia test pursuant to OECD Guideline 202.

In contrast to the known water-in-oil polymer dispersions, the water-in-water polymer dispersions are distinguished by the absence of a possibly combustible oil phase, due to which, besides the ecological aspects, improved effectiveness and handling of the dispersion and fire extinguishing agent results.

Due to this improved environmental compatibility and better handling, the water additives to be used according to the present invention are, from an ecological viewpoint, to be used in preference to the water additives according to the related art for fire protection and firefighting, above all in the countryside, preferably in forest fires or brush fires.

The residual monomer content of the water-in-water polymer dispersions to be used according to the present invention is preferably to be less than 1,000 ppm, preferably less than 500 ppm, and especially preferably less than 300 ppm. In order to reduce the residual monomer content to such a value, residual monomer destroyers may be used, for example, as are described in the parallel application having internal reference number ST0016, for example, which is hereby included as a reference and is thus considered part of the disclosure.

The water-in-water polymer dispersions to be used according to the present invention having a residual monomer content of less than 1000 ppm have EC₅₀ values of over 10 mg/l, sometimes over 100 mg/l, according to the daphnia test pursuant to OECD Guideline 202, and have EC₅₀ values of over 10 mg/l, determined according to the algae test pursuant to OECD Guideline 201, due to the reduction of the residual monomer content.

For the use according to the present invention of water-in-water polymer dispersions for fire protection and/or firefighting, the polymer dispersion is mixed with water or an aqueous liquid, preferably in a quantity which is sufficient to increase the viscosity of the resulting water/polymer dispersion mixture to over 100 mPa, and this mixture is introduced onto a surface and/or into the source of the flame.

In order to reach this viscosity, the polymer dispersion is mixed with water, preferably in a concentration of 0.01 to 50 volume-percent, especially preferably 0.02 to 10 volume-percent, and very especially preferably 1 to 2 volume-percent.

The mixture of water and/or aqueous liquid and polymer dispersion may be applied to the surfaces affected by fire using any typical firefighting device. Such devices are described, for example, in European Patent Application 0 774 279 B1 and in German Utility Model 299 04 848 U1. These publications are hereby introduced as a reference and are considered part of the disclosure.

The polymer dispersion may preferably be mixed with the water continuously or in batches.

The use according to the present invention of water-in-water polymer dispersions is distinguished in relation to the use of polymer dispersions known according to the related art by improved environmental compatibility. Therefore, the use according to the present invention of water-in-water polymer dispersions is especially suitable in the countryside, i.e., outside of places equipped with a sewer system or water retaining basins, such as for forest fires or brush fires.

A further object of the present invention is a device for fire protection and fire extinguishing, which comprises a pressure-resistant container containing the water and a water-in-water polymer dispersion.

The device may contain a mixture of water and/or an aqueous liquid and a water-in-water polymer dispersion, which is applied by a typical discharge device onto the source of the fire. The two components, specifically water and/or an aqueous liquid and the polymer dispersion, are, however, preferably initially housed separately from one another, in different, separated sections of the container, and are mixed with one another by operating a trigger mechanism known for this purpose and subsequently applied to the source of the fire by typical discharge devices.

The device according to the present invention is preferably a hand fire extinguisher or a fire engine, as are described in the related art, preferably in European Patent Application 0 774 279 B1 and in German Utility Model 299 04 848 U1.

### Testing Methods

### Determining the Viscosity of the Polymers

The viscosity was determined in a 0.5% solution in 10% aqueous table salt solution using a Brookfield viscosimeter.

### Toxicity in Relation to Microorganisms

The toxicity in relation to microorganisms was determined in accordance with the OECD “Guidelines for Testing of Chemicals”.

Specifically, these are OECD Guideline 201, “Algae, Growth Inhibition Test”, and OECD Guideline 202, “Daphnia Acute Immobilization Test and Reproduction Test” Part 1.

### EXAMPLES

In the following, the present invention is explained with reference to examples. These explanations are merely exemplary and do not restrict the general ideas of the present invention.

In this case, the following abbreviations are used:

| | |
|---|---|
| ABAH | 2.2′-azo-bis-amidinopropane-dihydrochloride |
| AMPS | 2-acrylamido-2-methylpropane sulfonic acid |
| TAMAC | triallyl methyl ammonium chloride |

### Comparative Example 1

This product is currently distributed by Stockhausen GmbH & Co. KG, Krefeld, as an additive for fire extinguishing water under the name Firesorb MF.

First, an aqueous monomer solution was produced from the following components:

```
457.0 g water
  84 g AMPS, sodium salt, 50% solution
  220 g acrylamide, 50% solution
  320 g acrylic acid
  320 g sodium hydroxide solution, 50% solution
  3.0 g formic acid, 85%
  1.0 ml Versenex ® 80
  2.3 g TAMAC
  0.5 g ABAH
```

Subsequently, 30 g Hypermer® 1083 was dissolved in 180 g RÖFSME and 300 g isotridecyl stearate and added to the aqueous monomer solution with stirring. After formation of the emulsion, it was mixed using a fast-running household mixer and freed of dissolved oxygen by flushing using nitrogen. The polymerization was started at 20° C. by adding 2 ml of a 0.2% tert-butyl hydroperoxide solution and 2.4 ml sulfur dioxide gas, the batch being heated to approximately 100° C. by the resulting polymerization heat. After cooling, 80 g isotridecyl alcohol-6 ethoxylate was stirred in. The toxicity in relation to microorganisms was determined in accordance with OECD Guidelines 201 and 202.

### Example 1

First, a monomer solution was produced from the following components:

```
100.0 g water
  20.0 g polyethylene glycol (MW: 20,000 g/mol)
  30.0 g acrylic acid
  16.7 g sodium hydroxide
  0.12 g triallyl methyl ammonium chloride
```

Subsequently, the solution was freed of oxygen by introducing nitrogen. After adding 1.2 ml 0.85 weight-percent aqueous ammonium persulfate solution and 3.0 ml of a 2% aqueous triethanolamine solution, the polymerization was started at 45° C. After termination of the polymerization, 10 ml of a sodium sulfite solution was added to the milky-cloudy dispersion.

The polymer dispersion obtained displayed improved algae toxicity according to the algae toxicity test on Scenedesmus subspicatus CD Guideline 201) and improved daphnia toxicity in relation to a water-in-oil dispersion according to Comparative Example 1.

### Example 2

30 g of a cross-linked, water-absorbing polyacrylic acid polymer of Stockhausen GmbH & Co. KG with the trade name FAVOR SXM 880 was introduced into 100 g of a 30 weight-percent solution of the commercial product POC HS 0010 from Degussa-Hüls AG, a polycarboxylic acid (MW: 4,500), with stirring. A liquid polymer dispersion was formed, whose residual monomer content of acrylic acid was 250 ppm.

The polymer dispersion obtained displayed improved algae toxicity according to the algae toxicity test on Scenedesmus subspicatus (OECD Guideline 201) and improved daphnia toxicity in relation to a water-in-oil dispersion according to Comparative Example 1.

### Example 3

First, a monomer solution was produced from the following components:

```
  45.0 g acrylamide
  15.0 g sodium acrylate
  5.0 g sodium-2-acrylamido-2-methyl propane sulfonate
  0.2 g methylene bisacrylamide
  8.0 g polyvinyl pyrrolidone (MW: 10,000 g/mol)
255.0 g water.
```

To the monomer solution is added 165 g ammonium sulfate and 10 g sodium sulfate and it was freed of oxygen by introducing nitrogen. With continuous moderate stirring, 30 mg potassium peroxodisulfate was added to the mixture to start the polymerization. The polymerization occurred at 25 to 30° C. with formation of finely dispersed, milky-cloudy liquid polymer dispersion. Subsequently, 15 ml of a sodium sulfide solution was added and the dispersion was heated to 40° C.

The polymer dispersion obtained displayed improved algae toxicity according to the algae toxicity test on Scenedesmus subspicatus (OECD Guideline 201) and improved daphnia toxicity in relation to a water-in-oil dispersion according to Comparative Example 1.

### Example 4

In this example, the properties of water-in-water polymer dispersions as fire protection and firefighting agents were evaluated. For this purpose, a polymer emulsion according to Example 1 was used.

A plywood board of 0.95 cm thickness and an area of 122 cm by 244 cm was coated with a 1.5% solution of the mixture of water and water-in-water polymer dispersion to a thickness of 0.32 to 0.6 4 cm. After application, the plywood was subjected to an open flame that was generated using a propane gas burner. The time for burning through was measured and compared to the burn through time of an identical, untreated plywood board. The burn through time of the treated plywood was 12 minutes. The burn through time of the untreated plywood was 3 minutes.

### Example 5

The procedure described in Example 4 was repeated using the polymer dispersion according to Example 2 instead of the polymer dispersion according to Example 1. The burn through time for the treated plywood was 10.minutes.

### Example 6

A plywood board was coated with a water-in-water polymer dispersion analogous to Example 2 and subjected to a heat treatment at a temperature of 2800 degrees. An identical, untreated plywood board was subjected to the identical conditions. The untreated board was completely enveloped in flames for 50 seconds and the wood was so strongly charred that the surface was burned away, so that the remnant was thinner. The coated board did not burn at all. Even the support behind the wall burned, but not the plywood board.

What is claimed:

1. A use of water-in-water polymer dispersions, comprising a continuous aqueous phase and cross-linked, water-swellable polymers dispersed therein and possibly auxiliary agents, for fire protection and/or firefighting.

2. The use according to claim 1, characterized in that the water-in-water polymer dispersions have a residual monomer content of less than 1000 ppm, preferably less than 500 ppm, and especially preferably less than 300 ppm.

3. The use according to claim 1 or 2, characterized in that the water-in-water polymer dispersion comprises:
A) 10 to 70 weight-percent, preferably 20 to 50 weight-percent, especially preferably 25 to 40 weight-percent of a cross-linked, water-swellable polymer,
B) 1 to 50 weight-percent, preferably 2 to 40 weight-percent, and especially preferably 5 to 35 weight-percent of at least one dispersion agent,
C) the remainder, up to 100 weight-percent, water.

4. The use according to claims 1 to 3, characterized in that the polymer comprises:
A) 1 to 99.9 weight-percent of at least one hydrophilic monomer,
B) 0.1 to 1 weight-percent of a polyfunctional cross-linking monomer,
C) 0 to 25 weight-percent of a hydrophobic monomer, and
D) 0 to 25 weight-percent of an amphiphilic monomer.

5. The use according to claims 1 to 4, characterized in that the polymer is a 5 polymer made of acrylic acid and/or an acrylic acid derivative.

6. The use according to claims 1 to 4, characterized in that the polymer is at least one polymer of the salt of acrylic acid and acrylamide.

7. The use according to claims 1 to 4, characterized in that the polymer is a terpolymer made of a salt of acrylic acid, acrylamide, and a salt of 2-acrylamido-2-methyl propane sulfonic acid.

8. The use according to claims 1 to 7, characterized in that triallyl methyl ammonium chloride is used as a cross-linker.

9. The use according to claims 1 to 8, characterized in that the particle diameter of the polymer particles is less than 2 μm and preferably less than 1 μm.

10. The use according to claims 1 to 9, characterized in that the swelling time of the polymer particles is not more than three seconds.

11. The use according to claims 1 to 10, characterized in that the water-in-water polymer dispersion contains at least one monopolymer and/or copolymer of acrylic acid and acrylic acid derivatives and/or maleic acid and maleic acid derivatives, preferably of an alkali salt of acrylic acid, polyol, preferably a polyalkylene glycol, polyvinyl alcohol, polyvinyl pyrrolidone, polyimine, and polydiallyl dimethyl ammonium chloride and/or an inorganic salt or a mixture of at least two of these substances as a dispersing agent.

12. The water-in-oil [sic] polymer dispersions according to claims 1 to 11, characterized in that they have an EC₅₀ value, established pursuant to OECD Guideline 202 and/or OECD Guideline 201, of more than 10 mg/l.

13. The use according to claims 1 to 12, characterized in that the water-in-water polymer dispersions are added to water in a quantity that is sufficient to increase the viscosity of the resulting water/polymer dispersion mixture to over 100 mPa, and this mixture is applied to the surface.

14. The use according to claim 13, characterized in that the polymer dispersion is added to water in a concentration of 0.01 to 50 volume-percent, preferably 0.02 to 10 volume-percent, and especially preferably 1 to 2 volume-percent.

15. The use according to claim 13 or 14, characterized in that the mixture of water and the water-in-water polymer dispersion has a viscosity of 500 to 50,000 mPa.

16. The use according to claims 13 to 15, characterized in that the water-in-water polymer dispersion is continuously mixed with the water in a typical discharge device for firefighting.

17. The use according to claims 13 to 15, characterized in that the polymer dispersion is mixed with the water in batches before it is applied by a discharge device.

18. A device for fire protection and fire extinguishing, characterized in that it comprises a pressure-resistant container that contains water and a water-in-water polymer dispersion.

19. The device according to claim 18, characterized in that it comprises a pressure-resistant container in which water and the water-in-water polymer dispersion are present separately from one another.

20. The device according to claim 18 or 19, characterized in that it is a hand fire extinguisher or a fire engine.
